(19) United States
(12) Patent Application Publication
(10) Pub. No.: US 2018/0138497 A1
(43) Pub. Date: May 17, 2018

(54) NA-DOPED AND NB-, W-, AND/OR MO-DOPED HE-NCM

(71) Applicant: Robert Bosch GmbH, Stuttgart (DE)

(72) Inventors: Malte Rolff, Stockelsdorf (DE); Anika Marusczyk, Stuttgart (DE); Thomas Eckl, Leonberg (DE)

(21) Appl. No.: 15/735,993

(22) PCT Filed: May 24, 2016
(86) PCT No.: PCT/EP2016/061639

§ 371 Date: Dec. 13, 2017

(30) Foreign Application Priority Data
Jun. 15, 2015 (DE) 102015210895.3

(51) Int. Cl. H01M 4/131; H01M 4/525; H01M 4/1391; H01M 4/505; H01M 4/36

(52) U.S. Cl. CPC H01M 4/131; H01M 4/525; H01M 2004/028; H01M 4/505; H01M 4/366; H01M 4/1391

(57) ABSTRACT

An active material for an electrochemical energy store, in particular for a lithium cell. To increase the service life of the electrochemical energy store, the active material is based on the general chemical formula: x(LiMO₂):1-x(Li_{2-y}Na_{y}Mn_{1-z}M′_{z}O₃), where M stands for nickel and/or cobalt and/or manganese and M′ stands for niobium and/or tungsten and/or molybdenum, and 0<x<1, 0<y<0.5, and 0<z<1. Moreover, an electrode material and an electrode that contains this active material, a process for manufacturing same, and an electrochemical energy store equipped with same, are described.

### FIELD

The present invention relates to an active material, an electrode material, and an electrode for an electrochemical energy store, in particular a lithium cell, a manufacturing method for same, and an electrochemical energy store equipped with same.

### BACKGROUND INFORMATION

The electrification of automobiles is making great advances at the present time, with the lithium-ion battery in particular being the focus of research. For applications in electric cars, batteries should have a long service life, for example greater than 10 years. The cell voltage and the energy released during a discharge should still be approximately 90% of the starting values even after 10 years, for example.

So-called high-energy materials, such as high-energy nickel-cobalt-manganese oxide (HE-NCM) of the general chemical formula: xLiMO₂:1-xLi₂MnO₃, where M stands for nickel (Ni), cobalt (Co), and manganese (Mn), also referred to as overlithiated layered oxide (OLO), are battery materials of great interest due to high start energy densities and start voltages, but thus far have a limited rate capability, and over their service life show a marked loss in the voltage level (“voltage fade”) that is accompanied by a capacity fade, for which reason they have not been commercially used to date.

W. He et al. describe a sodium-stabilized, layered Li_{1.2}[Co_{0.13}Ni_{0.13}Mn_{0.54}]O₂ cathode material in Journal of Materials Chemistry A, 2013, 1, pp. 11397-11403.

U.S. Patent App. Pub. No. U.S. 2009/0155691 A1 relates to a method for producing a lithium alkali transition metal oxide as a positive electrode material for a lithium secondary battery.

U.S. Patent App. Pub. No. U.S. 2008/0090150 A1 relates to active material particles of a lithium-ion secondary battery that includes at least a first lithium-nickel composite oxide.

European Patent No. EP 2 720 305 A1 relates to a cathode active material and a nickel composite hydroxide as a precursor of the cathode active material.

U.S. Patent App. Pub. No. U.S. 2009/0297947 A1 relates to nanostructured, dense, spherical layered positive active materials.

### SUMMARY

The present invention relates to a transition metal oxide-based active material, in particular a cathode active material or an active material for a positive electrode, for an electrochemical energy store, in particular for a lithium cell, for example for a lithium-ion cell, that is for example overlithiated, for example sodium-doped, in particular lithiatable, based on the general chemical formula:

x(LiMO₂):1-x(Li_{2-y}Na_{y}Mn_{1-z}M′_{z}O₃),

where M stands for nickel (Ni) and/or cobalt (Co) and/or manganese (Mn),
M′ stands for niobium (Nb) and/or tungsten (W) and/or molybdenum (Mo), for example for niobium (Nb) and/or tungsten (W), and 0<x<1, 0<y<0.5, and 0<z<1.

An active material may be understood in particular to mean a material which may take part in particular in a charging operation or discharging operation, and which may thus represent the actual active material.

Within the meaning of the present invention, an electrochemical energy store may be understood in particular to mean any battery. In particular, an energy store may include a primary battery or in particular a secondary battery, i.e., a rechargeable battery. A battery may include or be a galvanic element or a plurality of mutually connected galvanic elements. For example, an energy store may include a lithium-based energy store such as a lithium-ion battery. A lithium-based energy store, such as a lithium-ion battery, may be understood in particular to mean an energy store whose electrochemical processes during a charging or discharging operation are based at least partially on lithium ions. This type of energy store may be used, for example, as a battery for laptop, PDA, mobile phone, and other consumer applications, power tools, garden tools, and vehicles, for example hybrid vehicles, plug-in hybrid vehicles, and electric vehicles.

A lithium cell may be understood in particular to mean an electrochemical cell whose anode (negative electrode) includes lithium. For example, this may be a lithium-ion cell, which is a cell whose anode (negative electrode) includes an intercalation material, for example graphite and/or silicon, in which lithium is reversibly intercalatable and deintercalatable, or a lithium-metal cell, which is a cell with an anode (negative electrode) made of metallic lithium or a lithium alloy.

A lithiatable material may be understood in particular to mean a material that is able to reversibly absorb and release lithium ions. For example, a lithiatable material may be intercalatable with lithium ions and/or alloyable with lithium ions and/or absorb and release lithium ions with a phase transformation.

A transition metal may be understood in particular to mean an element having an atomic number of 21 to 30, 39 to 48, 57 to 80, and 89 to 112 in the periodic table.

Such active materials, for example high-energy (HE)-NCM materials, may advantageously have a greatly improved rate capability, a stabilized active material structure and an accompanying stabilization of the voltage level and capacity or prevention of at least significant reduction in the level of the voltage drop, and an improved output energy, in particular an increased output voltage and output capacity, and thus an increased discharge capacity.

By stabilizing the voltage level and capacity, in turn it is advantageously possible to increase the service life of a battery equipped in this way, and to make a high-energy battery, for example a high-energy lithium-ion battery, usable for commercial applications.

Overall, it is thus advantageously possible to increase the service life of an electrochemical energy store, for example a lithium cell such as a lithium-ion cell, and, for example, to provide an electrochemical energy store for commercial applications, in particular high-energy applications such as automotive applications.

Nickel, cobalt, and manganese may advantageously form lithium layered oxides whose electrochemical potentials, for example those for automotive applications, are of interest in particular with regard to a preferably high voltage level and high capacity.

By doping with sodium, which in particular may partially replace lithium, due to the larger ion radius of sodium the lithium position may be expanded, which may result in a reduction in the intrinsic material resistance and thus, a significant improvement in the rate capability.

For an active material based on the general formula x(LiMO₂):1-x(Li_{2-y}Na_{y}Mn_{1-z}M′_{z}O₃), in particular areas based on Li_{2-y}Na_{y}Mn_{1-z}M′_{z}O₃ may be structurally integrated into LiMO₂-based areas. In particular the doped Li_{2-y}Na_{y}Mn_{1-z}M′_{z}O₃-like areas may effectuate the stabilization of the active material structure and the accompanying stabilization of the voltage level and capacity, as well as improvement of the output voltage and output capacity, and thus, of the discharge capacity.

Niobium, in particular niobium(IV), tungsten, in particular tungsten(IV), and molybdenum, in particular molybdenum(IV), may advantageously have an ion radius that is very similar to redox-inactive tin(IV), known as a structure stabilizer. However, in contrast to redox-inactive tin(IV), niobium, in particular niobium(IV), tungsten, in particular tungsten(IV),und molybdenum, in particular molybdenum(IV), may be redox-active, in particular with a slight change in the ion radius, and in contrast to redox-inactive doping elements such as tin and magnesium, may advantageously provide additional capacity. An improved output energy density, in particular an increased output voltage and output capacity, and thus increased discharge capacity, compared to redox-inactive doping elements such as tin and magnesium may thus advantageously be achieved.

During the formation, the Li_{2-y}Na_{y}Mn_{1-z}M′_{z}O₃ component, which at the beginning is still electrochemically inactive with respect to manganese, may be activated with irreversible splitting off of oxygen, it being possible for portions of the Mn(IV) to be replaced by electrochemically active niobium, in particular niobium(IV), tungsten, in particular tungsten(IV), and/or molybdenum, in particular molybdenum(IV). The necessary activation of the material and thus, formation of oxygen voids, which would facilitate the migration of transition metals, in particular manganese and/or nickel, and thus a voltage drop, for example due to localized structural changes in the active material, may thus be reduced. In particular, it is thus possible for less oxygen to be irreversibly split off than with an undoped material or a material that is doped with a redox-inactive element, for example tin(IV). This may advantageously result in stabilization of the structure and thus of the voltage level, since fewer voids arise in the active material or electrode material, via which transition metals, in particular manganese and/or nickel, migrate and which may thus alter or destabilize the structure.

M′ may in particular stand for niobium(IV) and/or tungsten(IV) and/or molybdenum(IV). Niobium(IV), tungsten(IV), and molybdenum(IV) may advantageously have an ion radius, for example in a range of ≥70 pm to ≤85 pm, that is virtually identical to the ion radius of structure-stabilizing but redox-inactive tin(IV). An expansion of the crystal lattice, which may be characterized, for example, by an increase in the lattice parameters a, b, and/or c, may facilitate the migration of transition metals, in particular manganese and/or nickel, during the cyclization. In contrast, due to doping with niobium(IV) and/or tungsten(IV) and/or molybdenum(IV) and the resulting reduction in released oxygen during the activation, it is advantageously possible to reduce an expansion of the crystal lattice in the active material or electrode material, and thus a migration of transition metals, in particular manganese and/or nickel, and also to protect from dissolution of transition metal, in particular manganese and/or nickel. The drop in capacity and voltage may thus advantageously be further reduced, and the service life of the electrochemical energy store, for example a lithium cell and/or lithium battery, increased.

In addition, niobium(IV), tungsten(IV), and molybdenum(IV) may advantageously have a slight change in the ion radius during at least two successive oxidation steps, in particular when undergoing the redox reaction. For example, during at least two successive oxidation steps, niobium(IV), tungsten(IV), and molybdenum(IV) may have an ion radius which may in each case be in a range of ≥70 pm to ≤85 pm, for example. Since a great change in the ion radius during the cyclization would further facilitate the migration of the transition metals, by slightly changing the ion radius better protection from dissolution of the transition metals may be provided, and the active material or electrode material may be further stabilized.

M may in particular stand for nickel(II) and/or cobalt (II) and/or manganese (II). For example, 0.2≤x 5≤0.7, for example 0.3≤x≤0.55, may apply. For example, M may stand for manganese (Mn) and nickel (Ni) and/or cobalt.

Within the scope of one specific embodiment, M stands for nickel (Ni), cobalt (Co), and manganese (Mn).

Within the scope of one particular embodiment of this specific embodiment, the at least one active material is based on the general chemical formula:

x(LiNiₐCo_{b}Mn_{1-a-b}O₂):1-x(Li_{2-y}Na_{y}Mn_{1-z}M′_{z}O₃),
where 0 ≤a≤1, for example 0.2≤a≤0.8, for example 0.3≤a≤0.45, and 0≤b≤1, for example 0≤b≤0.5, for example 0.2≤b≤0.35. For example, a and b may stand for 1/3, with LiNiₐCo_{b}Mn_{1-a-b}O₂ being LiMn_{1/3}Ni_{1/3}Co_{1/3}O₂, for example.

Within the scope of another specific embodiment, 0.01≤z≤0.3. In particular, 0.01≤z≤0.2 may apply.

Within the scope of another specific embodiment, M′ stands for niobium, in particular niobium(IV), and/or tungsten, in particular tungsten(IV).

With regard to further technical features and advantages of the active material according to the present invention, explicit reference is hereby made to the explanations in conjunction with the electrode material according to the present invention, the manufacturing method according to the present invention, the electrode according to the present invention, the electrochemical energy store according to the present invention, and to the figures and the description of the figures.

The present invention further relates to an electrode material, in particular a cathode material or an electrode material for a positive electrode, for an electrochemical energy store, in particular for a lithium cell, for example for a lithium-ion cell, that includes particles containing at least one lithiatable transition metal oxide-based active material that is for example overlithiated, in particular doped with sodium (Na), the particles or a base body containing the particles being at least partially provided with, or being, a functional layer that is conductive for lithium ions and includes niobium (Nb) and/or tungsten (W) and/or molybdenum (Mo).

A particle may be understood in particular to mean a primary particle and/or a secondary particle, for example of a starting powder.

A base body may be understood in particular to mean a body, which for example is finished, made of electrode material, and which includes or is made of particles that contain the at least one active material.

A functional layer may be understood in particular to mean a protective layer that prevents interaction of the active material with an electrolyte, for example when used in a lithium cell.

By providing the functional layer, which is conductive for lithium ions and includes niobium, tungsten, and/or molybdenum, it is advantageously possible to provide very effective protection of the active material or electrode material from loss or dissolution of the transition metals, in particular manganese and/or nickel, in an electrolyte, which otherwise could result in deposition of lithium-containing transition metal compounds on the anode, and thus, in a loss of available transition metal and/or lithium, and thus, capacity fade. The functional layer may advantageously function as a type of barrier, the structure-stabilizing and redox-active niobium, tungsten, and/or molybdenum preventing an interaction of the active material of the particles with an electrolyte, for example when used in a lithium cell, and thus allowing prevention of dissolution or elutriation of the transition metal. A reduction in the capacity fade and thus an increase in the service life of the lithium cell and/or lithium battery may thus advantageously be achieved.

During coating of the particles or of the base body containing the particles, the doping with niobium, tungsten, and/or molybdenum into the at least one active material, in particular the Li_{2-y}Na_{y}Mn_{1-z}M′_{z}O₃ component, may be introduced in one method step. Thus, using only one method step, it is advantageously possible in a very efficient and cost-effective manner to counteract two key problems of HE-NCM materials, namely, the capacity fade due to the functional layer, and the voltage drop due to the doping with niobium, tungsten, and/or molybdenum originating from the functional layer.

For example, the at least one active material, in particular the particle, may include or be at least one transition metal oxide-based active material, for example manganese oxide, in particular nickel-cobalt-manganese oxide, that is for example overlithiated, for example sodium-doped, in particular lithiatable.

Within the scope of one specific embodiment of the present invention, the at least one active material, in particular the particle, is based on the general chemical formula: x(LiMO₂):1-x(Li_{2-y}Na_{y}MnO₃), where M stands for nickel (Ni) and/or cobalt (Co) and/or manganese (Mn), and 0<x<1 and 0<y<0.5. For example, M may stand for manganese (Mn) and nickel (Ni) and/or cobalt.

Within the scope of one embodiment of this specific embodiment, M stands for nickel (Ni), cobalt (Co), and manganese (Mn).

In particular the at least one active material, in particular the particle, may be based on the general chemical formula:

x(LiNiₐCo_{b}Mn_{1-a-b}O₂):1-x(Li_{2-y}Na_{y}MnO₃),

where 0≥a≥1, for example 0.2≥a≥0.8, for example 0.3≥a≥0.45, and 0≥b≥1, for example 0≥b≥0.5, for example 0.2≥b≥0.35.

The functional layer may in particular include niobium(IV) and/or tungsten(IV) and/or molybdenum(IV).

Within the scope of one specific embodiment, the functional layer includes niobium, in particular niobium(IV), and/or tungsten, in particular tungsten(IV).

As explained above, the at least one active material, in particular the particle, may be doped with niobium, tungsten, and/or molybdenum from the functional layer. In particular, the at least one active material, in particular the particle, may therefore include or be a, for example, overlithiated manganese oxide, in particular nickel-cobalt-manganese oxide, that is doped with sodium and niobium and/or tungsten and/or molybdenum, for example with sodium and niobium and/or tungsten.

Within the scope of another specific embodiment, the at least one active material, in particular the particle, includes or is an active material according to the present invention explained above.

In addition to the particles, the base body may include, for example, at least one conductive additive, for example elemental carbon, for example carbon black, graphite, and/or carbon nanotubes, and/or at least one binder, for example selected from the group of natural or synthetic polymers, for example polyvinylidene fluoride (PVDF), alginates, styrene butadiene rubber (SBR), polyethylene glycol, and/or polyethylenimine.

The base body may, for example, have a gradient of niobium, tungsten, and/or molybdenum that points in the thickness direction of the base body. The gradient, in particular starting from the functional layer, may for example decrease toward a metal support that is used as a current collector. This may advantageously be sufficient, since the interaction of the active material with the electrolyte takes place predominantly in the surface area, and the costs may thus be reduced by using the redox-active doping elements.

In addition, a coating of the particles and/or the base body, for example aluminum oxide (Al₂O₃), aluminum fluoride (AlF₃), lithium aluminum oxide (LiAlOₓ), zirconium dioxide (ZrO₂), titanium dioxide (TiO₂), aluminum phosphate (AlPO₄), and/or lithium phosphorous oxynitride (LiPON) and/or some other compound which for example may reduce transition metal dissolution and/or other material-electrolyte interactions (single particle coating), may optionally be present.

With regard to further technical features and advantages of the electrode material according to the present invention, explicit reference is hereby made to the explanations in conjunction with the active material according to the present invention, the manufacturing method according to the present invention, the electrode according to the present invention, the electrochemical energy store according to the present invention, and to the figures and the description of the figures.

The present invention further relates to a method for manufacturing an active material, in particular a cathode active material and/or an electrode material, in particular a cathode material, and/or an electrode, in particular a cathode or positive electrode, for an electrochemical energy store. In particular, the method may be designed for manufacturing an active material according to the present invention and/or an electrode material according to the present invention and/or an electrode according to the present invention.

The method may include in particular the method steps:
providing particles containing at least one lithiatable, transition metal oxide-based active material or a base body containing the particles, the at least one active material being manufactured with the aid of a polymer pyrolysis method and/or being doped with sodium; and
coating the particles and/or the base body with a functional layer that is conductive for lithium ions and includes niobium (Nb) and/or tungsten (W) and/or molybdenum (Mo).

For example, the at least one active material, in particular the particle, may include or be at least one transition metal oxide-based active material, for example manganese oxide, in particular nickel-cobalt-manganese oxide, that is for example overlithiated, for example doped with sodium, in particular lithiatable.

By use of the method, on the one hand a protective functional layer for the active material may be provided very easily in order to prevent dissolution or elutriation of transition metals, in particular nickel and/or manganese, and the accompanying capacity fade. On the other hand, the method may additionally provide the significant advantage that a portion of the niobium and/or tungsten and/or molybdenum of the functional layer may be introduced into the active material as a doping element during the coating of the particles or the base body.

Doping of the active material with niobium and/or tungsten and/or molybdenum may thus be advantageously effectuated, which in return may result in structural stabilization. As explained above, the structural stabilization may be attributed to the fact that during the first formation cycle, in which the electrochemically inactive Li₂MnO₃ component is activated, less oxygen is irreversibly split off, and thus fewer oxygen voids are formed than with the undoped HE-NCM material. Accordingly, by use of only one method step, two key problems of the HE-NCM material may be taken into account: namely, the capacity fade due to the coating of the particles or the base body with the functional layer, and the voltage drop due to the concurrent doping of the active material with redox-active niobium and/or tungsten and/or molybdenum originating from the functional layer.

Thus, for example, when providing or producing the particles, for example by the polymer pyrolysis method, admixing at least one compound containing niobium and/or tungsten and/or molybdenum, and, for example, also a coating based on redox-inactive elements, for example containing Al₂O₃, LiAlOₓ, ZrO₂, TiO₂, AlPO₄, LiPON, a magnesium compound, and/or a tin compound, may be dispensed with in order to introduce, in a single process step, material doping for controlling the drop in the voltage level as well as a protective layer for controlling the capacity fade.

Within the scope of one specific embodiment, the polymer pyrolysis method includes the method steps:
dissolving and/or dispersing at least one lithium salt and a transition metal salt in a solution containing at least one polymerizable monomer;
polymerizing the at least one polymerizable monomer to produce at least one polymer;
pyrolyzing the at least one polymer; and
calcining the residue remaining after the pyrolysis.

For example, the at least one polymerizable monomer may include or be acrylic acid. The at least one polymer may in particular include or be a polyacrylate.

As the result of the salts being initially dissolved in the monomer-containing solution and the monomers then being polymerized to produce a polymer, a polymer-metal salt precursor, for example a polyacrylate, may advantageously be formed, in particular in which the metals are present in finely distributed form.

The solution may be an aqueous solution, for example.

Within the scope of one embodiment of this specific embodiment, at least one lithium salt, a sodium salt, and a transition metal salt, in particular manganese salt, are dissolved and/or dispersed in the solution. In addition, at least one nickel salt and/or cobalt salt, for example, may be dissolved and/or dispersed in the solution. For example, at least one lithium salt, a sodium salt, a manganese salt, a nickel salt, and a cobalt salt may be dissolved and/or dispersed in the solution.

The lithium salt may, for example, include or be lithium hydroxide, for example LiOH.H₂O. The sodium salt may, for example, include or be sodium hydroxide, for example NaOH. The manganese salt may, for example, include or be a manganese(II) salt and/or manganese nitrate, in particular manganese(II) nitrate, for example Mn(NO₃)₂. The nickel salt may, for example, include or be a nickel(II) salt and/or nickel nitrate, in particular nickel(II) nitrate, for example Ni(NO₃)₂.6H₂O. The cobalt salt may, for example, include or be a cobalt(II) salt and/or cobalt nitrate, in particular cobalt(II) nitrate, for example Co(NO₃)₂.6H₂O.

The metal salts may be used in stoichiometric quantities, for example. However, in particular an excess, for example 5%, of the lithium salt may be used. A loss of lithium during the subsequent calcining may thus advantageously be compensated for.

For polymerizing the at least one polymerizable monomer, for example acrylic acid, to produce the at least one polymer, for example polyacrylate, in particular at least one polymerization initiator may be added to the solution and/or dispersion. For example, at least one peroxodisulfate, for example ammonium peroxodisulfate, for example (NH₄)₂S₂O₈, may be used as polymerization initiator.

The at least one polymer may optionally be dried, in particular prior to the pyrolysis, for example at a temperature of 100° C., for example approximately 120° C.

The pyrolyzing of the at least one polymer may be carried out in particular under an air atmosphere. For example, the pyrolyzing of the at least one polymer may be carried out at a temperature of 450° C., for example at approximately 480° C. For example, the pyrolyzing may be carried out over a period of 4 h, for example approximately 5 h.

The calcining of the residue remaining after the pyrolysis may in particular likewise be carried out under an air atmosphere.

For example, the calcining of the residue remaining after the pyrolysis may be carried out at a temperature of 850° C., for example at approximately 900° C. For example, the calcining may be carried out over a period of 4 h, for example approximately 5 h.

For example, the at least one active material, in particular the particle, may be based on the general chemical formula: x(LiMO₂):1-x(Li_{2-y}Na_{y}MnO₃), where M stands for nickel (Ni) and/or cobalt (Co) and/or manganese (Mn), and 0<x<1 and 0<y<0.5. For example, M may stand for manganese (Mn) and nickel (Ni) and/or cobalt (Co). In particular, M may stand for nickel (Ni), cobalt (Co), and manganese (Mn). For example, the at least one active material, in particular the particle, may be based on the general chemical formula: x(LiNiₐCo_{b}Mn_{1-a-b}O₂):1-x(Li_{2-y}Na_{y}MnO₃), where 0≤a≤1, for example 0.2≤a≤0.8, for example 0.3≤a≤0.45, and 0≤b≤1, for example 0≤b≤0.5, for example 0.2≤b≤0.35.

The functional layer may in particular include niobium(IV) and/or tungsten(IV) and/or molybdenum(IV).

Within the scope of another specific embodiment, the functional layer includes niobium, in particular niobium (IV), and/or tungsten, in particular tungsten(IV).

The coating of the particles, for example primary and/or secondary particles, with the functional layer may take place in particular in such a way that the particles, for example a powder obtained by the polymer pyrolysis method, are/is mixed, for example in water and/or some other dispersion medium, together with at least one compound containing niobium (Nb) and/or tungsten (W) and/or molybdenum (Mo). The solids in the dispersion may then be separated, for example filtered off. The solids or the residue may then optionally be dried, for example at a temperature of 100° C., for example at approximately 105° C., for example for several hours, for example approximately 10 h. The solids may (then) be calcined at a temperature of 450° C., for example for several hours, for example for approximately 5 h. However, other coating methods known to those skilled in the art, such as sputtering, with at least one compound containing niobium and/or tungsten and/or molybdenum may be carried out for coating the particles with the functional layer.

The coating of the base body or the finished, for example laminated, electrode with the functional layer may be carried out with the aid of methods known to those skilled in the art, for example atomic layer deposition and/or sputtering, using at least one compound containing niobium and/or tungsten and/or molybdenum.

Li₇La₃Nb₂O₁₃, Li₇NbO₆, Li₃NbO₄, LiTiNb₂O₉, and/or Li₈₋ₓZr₁₋ₓNbₓO₆, for example, may be used as the niobium compound. Li₆WO₆, Li₄WO₅, and/or Li₆W₂O₉, for example, may be used as the tungsten compound.

Within the scope of one embodiment, in particular within the scope of which the particles are coated (single particle coating), the method may include the following method steps:
providing particles containing at least one lithiatable transition metal oxide-based active material or a base body containing the particles, the at least one active material being manufactured with the aid of a polymer pyrolysis method and/or doped with sodium;

in particular, the polymer pyrolysis method including the method steps:
dissolving and/or dispersing at least one lithium salt and a transition metal salt in a solution containing at least one polymerizable monomer;
polymerizing the at least one polymerizable monomer to produce at least one polymer;
optionally drying the at least one polymer;
pyrolyzing the at least one polymer; and
calcining the residue remaining after the pyrolysis;
coating the particles with a functional layer that is conductive for lithium ions and includes niobium and/or tungsten and/or molybdenum, for example niobium and/or tungsten;
adding a conductive additive and a binder;
dry-pressing the components from the group made up of the particles with the functional layer, the conductive additive, and the binder, or dispersing the component from the group made up of the particles with the functional layer, the conductive additive, and the binder in a solvent, for example N-methyl-2-pyrrolidone;
applying the pressed composite thus obtained, or applying, in particular blade coating, the dispersion thus obtained to a metal support, for example an aluminum foil; and
optionally drying the dispersion.

Within the scope of one embodiment of the present invention, in particular within the scope of which the base body is coated (laminate coating), the method may include the following method steps:
providing particles containing at least one lithiatable transition metal oxide-based active material or a base body containing the particles, the at least one active material being manufactured with the aid of a polymer pyrolysis method and/or doped with sodium;

in particular the polymer pyrolysis method including the method steps:
dissolving and/or dispersing at least one lithium salt and a transition metal salt in a solution containing at least one polymerizable monomer;
polymerizing the at least one polymerizable monomer to produce at least one polymer;
optionally drying the at least one polymer;
pyrolyzing the at least one polymer; and
calcining the residue remaining after the pyrolysis;
adding a conductive additive and a binder;
dry-pressing the components from the group made up of the particles, the conductive additive, and the binder, or dispersing the component from the group made up of the particles, the conductive additive, and the binder in a solvent, for example N-methyl-2-pyrrolidone;
applying the pressed composite thus obtained, or applying, in particular blade coating, the dispersion thus obtained to a metal support, for example an aluminum foil, to form a base body containing the particles;
optionally drying the dispersion;
coating the base body with a functional layer that is conductive for lithium ions and includes niobium and/or tungsten and/or molybdenum, for example niobium and/or tungsten.

Moreover, the present invention relates to an active material that is manufactured by a method according to the present invention and/or an electrode material that is manufactured by a method according to the present invention.

With regard to further technical features and advantages of the manufacturing method according to the present invention and the active material or electrode material manufactured by same, explicit reference is hereby made to the explanations in conjunction with the active material according to the present invention, the electrode material according to the present invention, the electrode according to the present invention, the electrochemical energy store according to the present invention, and to the figures and the description of the figures.

The present invention further relates to an electrode, in particular a cathode, that includes at least one active material according to the present invention and/or an active material that is manufactured by a method according to the present invention, and/or an electrode material according to the present invention and/or an electrode material that is manufactured by a method according to the present invention, and/or that is manufactured by a method according to the present invention.

With regard to further technical features and advantages of the electrode according to the present invention, explicit reference is hereby made to the explanations in conjunction with the active material according to the present invention, the electrode material according to the present invention, the manufacturing method according to the present invention, the electrochemical energy store according to the present invention, and to the figures and the description of the figures.

A further subject matter of the present invention relates to an electrochemical energy store, in particular a lithium cell and/or lithium battery, for example a lithium-ion cell and/or lithium-ion battery, including an active material according to the present invention and/or an active material that is manufactured by a method according to the present invention, and/or an electrode material according to the present invention and/or an electrode material that is manufactured by a method according to the present invention, and/or an electrode according to the present invention and/or an electrode that is manufactured by a method according to the present invention.

With regard to further technical features and advantages of the electrochemical energy store according to the present invention, explicit reference is hereby made to the explanations in conjunction with the active material according to the present invention, the electrode material according to the present invention, the manufacturing method according to the present invention, the electrode according to the present invention, and to the figures and the description of the figures.

### BRIEF DESCRIPTION OF THE DRAWINGS

Further advantages and advantageous embodiments of the present invention are illustrated in the figures and explained in the description below. The figures are only descriptive in nature, and are not intended to limit the present invention in any way.

FIG. 1 shows a schematic cross section of one specific embodiment of an electrode.

FIG. 2 shows a schematic cross section of one specific embodiment of a particle that is coated with a functional layer.

FIG. 3 shows a schematic cross section of another specific embodiment of an electrode.

FIG. 4 shows a flow chart of one specific embodiment of a method according to the present invention for manufacturing an electrode shown in FIG. 1.

FIG. 5 shows a flow chart of another specific embodiment of a method according to the present invention for manufacturing an electrode shown in FIG. 3.

### DETAILED DESCRIPTION OF EXAMPLE EMBODIMENTS

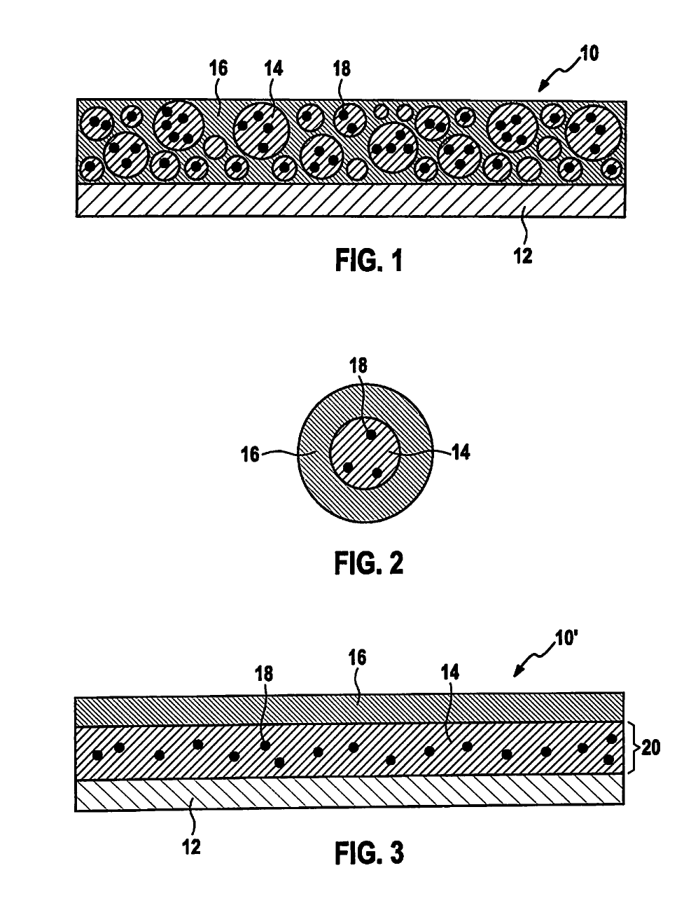

FIG. 1 illustrates an electrode 10 that includes a metal support 12. Metal support 12 may be used in a lithium cell or lithium battery as an arrester, in particular a cathode arrester. Electrode 10 also includes a plurality of particles 14 that are situated on metal support 12. Particles 14 contain at least one lithiatable transition metal oxide-based active material that is doped with sodium.

As is apparent from FIGS. 1 and 2, particles 14 are provided or coated with a functional layer 16. Functional layer 16 according to the present invention is conductive for lithium ions, and includes niobium and/or tungsten and/or molybdenum.

Due to the redox-active niobium and/or tungsten and/or molybdenum, functional layer 16 is designed in such a way that it may prevent an interaction of the active material with an electrolyte, for example during use or operation of a lithium cell, and may thus protect the electrode from loss of transition metal. Particles 14 may be completely or also only partially enclosed by functional layer 16. Individual depiction of functional layers 16 of all particles 14 is dispensed with in FIG. 1 for the purpose of illustration. It is quite conceivable for a number of particles 14 to be situated on the surface of electrode 10 and to protrude therefrom without being covered by functional layer 16.

As also illustrated in FIGS. 1 and 2, a majority of particles 14 also contain redox-active niobium and/or tungsten and/or molybdenum 18 as a doping element. In particular, particles 14 contain at least one active material that is doped with niobium and/or tungsten and/or molybdenum 18. The redox-active niobium and/or tungsten and/or molybdenum may in particular originate from functional layer 16. In addition to the at least one active material, electrode 10 may also include at least one conductive additive and at least one binder (not illustrated). For example, the at least one active material, the at least one conductive additive, and the at least one binder may form the electrode material of electrode 10.

FIG. 3 illustrates an electrode 10′ which, similarly to electrode 10 in FIG. 1, includes a metal support 12. A base body 20 that includes particles 14 or is made of particles 14 is situated on metal support 12. Individual particles 14 are uncoated, and likewise contain the at least one lithiatable transition metal oxide-based active material that is doped with sodium. In addition to the active material, electrode 10′ or base body 20 may include a suitable conductive additive and a suitable binder (not illustrated). FIG. 3 also shows that base body 20 is provided with functional layer 16. Functional layer 16, similarly to the functional layer explained in conjunction with FIGS. 1 and 2, is conductive for lithium ions and includes niobium and/or tungsten and/or molybdenum. Due to its composition, functional layer 16 may in particular be designed in such a way that it may prevent an interaction of the active material with an electrolyte, for example when a lithium cell is used or operated, and may thus protect electrode 10′ from loss of transition metal. Electrode 10′ may be finished by lamination, for example, before the coating of base body 20 with functional layer 16 takes place.

As also illustrated in FIGS. 1 and 2, electrode 10′ or base body 20 also includes redox-active niobium and/or tungsten and/or molybdenum 18 as a doping element. In particular, base body 20 or particles 14 of base body 20 contain(s) at least one active material that is doped with niobium and/or tungsten and/or molybdenum 18. The redox-active niobium and/or tungsten and/or molybdenum may in particular originate from functional layer 16. In addition, base body 20 may have a gradient of redox-active niobium and/or tungsten and/or molybdenum 18 that points in the thickness direction of the base body. The gradient of redox-active niobium and/or tungsten and/or molybdenum 18 may in particular decrease from functional layer 16 toward metal support 12.

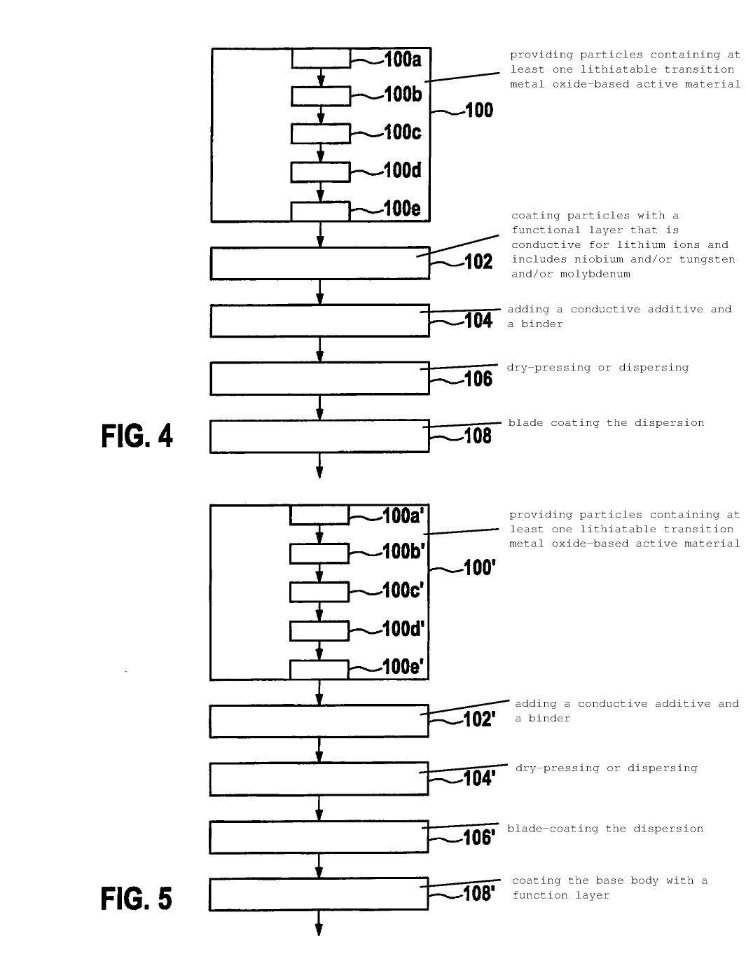

FIG. 4 shows a flow chart of a method for manufacturing an electrode 10, in particular a cathode for a lithium cell, according to FIG. 1 (single particle coating). The method includes a step of providing 100 particles 14 containing at least one lithiatable transition metal oxide-based active material, the at least one active material being manufactured with the aid of a polymer pyrolysis method 100a, 100b, 100c, 100d, 100e and/or doped with sodium. The polymer pyrolysis method includes a step of dissolving and/or dispersing 100a at least one lithium salt and a transition metal salt in a solution containing at least one polymerizable monomer; a step of polymerizing 100b the at least one polymerizable monomer to produce at least one polymer; optionally a step of drying 100c the at least one polymer, a step of pyrolyzing 100d the at least one polymer, and a step of calcining 100e the residue remaining after the pyrolysis. In addition, the method includes step 102 of coating 102 particles 14 with a functional layer 16 that is conductive for lithium ions and includes niobium and/or tungsten and/or molybdenum, step 104 of adding 104 a conductive additive and a binder, a step of dry-pressing 106 the components from the group made up of particles 14 with functional layer 16, the conductive additive, and the binder, or a step of dispersing 106 the component from the group made up of particles 14 with functional layer 16, the conductive additive, and the binder in a solvent, a step of applying 108 the pressed composite thus obtained or applying 108, in particular blade coating, the dispersion thus obtained to a metal support 12, and optionally a step of drying the dispersion (not illustrated).

FIG. 5 shows a flow chart of a method for manufacturing an electrode 10′, in particular a cathode for a lithium cell, according to FIG. 3 (laminate coating). The method includes a step of providing 100′ particles 14 containing at least one lithiatable transition metal oxide-based active material, the at least one active material being manufactured with the aid of a polymer pyrolysis method 100a′, 100b′, 100c′, 100d′, 100e′ and/or doped with sodium. The polymer pyrolysis method includes a step of dissolving and/or dispersing 100a′ at least one lithium salt and a transition metal salt in a solution containing at least one polymerizable monomer; a step of polymerizing 100b′ the at least one polymerizable monomer to produce at least one polymer; optionally a step of drying 100c′ the at least one polymer, a step of pyrolyzing 100d′ the at least one polymer, and a step of calcining 100e′ the residue remaining after the pyrolysis. In addition, the method includes the step of adding 102′ a conductive additive and a binder, a step of dry-pressing 104′ the components from the group made up of particles 14, the conductive additive, and the binder, or a step of dispersing 104′ the component from the group made up of particles 14, the conductive additive, and the binder in a solvent, a step of applying 106′ the pressed composite thus obtained or applying 106′, in particular blade coating, the dispersion thus obtained to a metal support 12 in order to form a base body 20 containing particles 14, optionally a step of drying the dispersion (not illustrated) and a step of coating 108′ base body 20 with a functional layer 16 that is conductive for lithium ions and includes niobium and/or tungsten and/or molybdenum.

1-15. (canceled)

16. An cathode active material for an electrochemical energy store, the electrochemical energy store being a lithium cell, the active material being based on the general chemical formula:
x(LiMO₂):1-x(Li_{2-y}Na_{y}Mn_{1-z}M′_{z}O₃),
where M stands for at least one of nickel, cobalt, and manganese,
M′ stands for at least one of niobium, tungsten, and molybdenum, and 0<x<1, 0<y<0.5, and 0<z<1.

17. The cathode active material as recited in claim 16, wherein M stands for nickel, cobalt, and manganese, and the at least one active material is based on the general chemical formula:
x(LiNiₐCo_{b}Mn_{1-a-b}O₂):1-x(Li_{2-y}Na_{y}Mn_{1-z}M′_{z}O₃),
where 0.2≤a≤0.8, and 0≤b≤0.5.

18. The cathode active material as recited in claim 16, wherein at least one of: (i) M′ stands for at least one of niobium and tungsten, and (ii) 0.01≤z≤0.2.

19. An cathode electrode material for an electrochemical energy store, the electrochemical energy store being a lithium cell, the cathode electrode material including particles containing at least one lithiatable transition metal oxide-based active material that is doped with sodium, one of the particles or a base body that contains the particles, being at least partially provided with, or being, a functional layer (16) that is conductive for lithium ions and includes at least one of niobium, tungsten, and molybdenum.

20. The cathode electrode material as recited in claim 19, wherein the functional layer includes at least one of niobium(IV) and tungsten(IV).

21. The cathode electrode material as recited in claim 19, wherein the at least one active material is based on the general chemical formula:
x(LiMO₂):1-x(Li_{2-y}Na_{y}MnO₃),
where M stands for at least one of nickel, cobalt, and manganese, and
0<x<1 and 0<y<0.5.

22. The cathode electrode material as recited in claim 19, wherein the at least one active material is based on the general chemical formula:
x(LiNiₐCo_{b}Mn_{1-a-b}O₂):1-x(Li_{2-y}Na_{y}MnO₃),
where M in stands for nickel, cobalt, and manganese, and
where 0.2≤a≤0.8, and 0≤b≤0.5.

23. The electrode material as recited in claim 19, wherein the at least one active material includes or is an active material which is based on the general chemical formula:
x(LiMO₂):1-x(Li_{2-y}Na_{y}Mn_{1-z}M′_{z}O₃),
where M stands for at least one of nickel, cobalt, and manganese,
M′ stands for at least one of niobium, tungsten, and molybdenum, and 0<x<1, 0<y<0.5, and 0<z<1.

24. A method for manufacturing at least one of an cathode active material, a cathode electrode material, and a cathode electrode, for an electrochemical energy store, the energy store being a lithium cell, the method comprising:
providing particles containing at least one lithiatable transition metal oxide-based active material or a base body containing the particles which contain at least one lithiatable transition metal oxide-based active material, the at least one active material being at least one of manufactured with the aid of a polymer pyrolysis method, and doped with sodium; and
coating at least one of the particles and the base body, with a functional layer that is conductive for lithium ions and includes at least one of niobium, tungsten, and molybdenum.

25. The method as recited in claim 24, wherein the polymer pyrolysis method includes:
at least one of dissolving and dispersing at least one lithium salt and a transition metal salt in a solution containing at least one polymerizable monomer, in particular acrylic acid;
polymerizing the at least one polymerizable monomer to produce at least one polymer, the at least one polymer including polyacrylate;
pyrolyzing the at least one polymer; and
calcining the residue remaining after the pyrolysis.

26. The method as recited in claim 25, wherein at least one lithium salt, a sodium salt, and a transition metal salt are one of dissolved and dispersed in the solution.

27. The method as recited in claim 26, wherein the transition metal salt is manganese salt.

28. The method as recited in claim 25, wherein at least one lithium salt, a sodium salt, a manganese salt, a nickel salt, and a cobalt salt are at least one of dissolved and dispersed in the solution.

29. The method as recited in claim 25, wherein the functional layer includes at least one of niobium and tungsten.

30. The method as recited in claim 25, wherein the at least one active material is based on the general chemical formula:
x(LiMO₂):1-x(Li_{2-y}Na_{y}MnO₃),
where M stands for at least one of nickel, cobalt, and manganese, and
0<x<1 and 0<y<0.5.

31. The method as recited in claim 25, wherein the at least one active material is based on the general chemical formula:
x(LiNiₐCo_{b}Mn_{1-a-b}O₂):1-x(Li_{2-y}Na_{y}MnO₃),
where 0.2≤a≤0.8, and 0≤b≤0.5.

32. An a cathode that includes at least one active material, the active material being based on the general chemical formula:
x(LiMO₂):1-x(Li_{2-y}Na_{y}Mn_{1-z}M′_{z}O₃),
where M stands for at least one of nickel, cobalt, and manganese,
M′ stands for at least one of niobium, tungsten, and molybdenum, and 0<x<1, 0<y<0.5, and 0<z<1.

33. An electrochemical energy store that includes at least one active material, the active material being based on the general chemical formula:
x(LiMO₂):1-x(Li_{2-y}Na_{y}Mn_{1-z}M′_{z}O₃),
where M stands for at least one of nickel, cobalt, and manganese,
M′ stands for at least one of niobium, tungsten, and molybdenum, and 0<x<1, 0<y<0.5, and 0<z<1.
